(19) United States
(12) Patent Application Publication
(10) Pub. No.: US 2006/0239737 A1
(43) Pub. Date: Oct. 26, 2006

(54) Inkjet image forming apparatus and method of controlling the same

(76) Inventor: Chun-Ku Han, Suwon-si (KR)

Correspondence Address: STANZIONE & KIM, LLP, 919 18TH STREET, N.W., SUITE 440, WASHINGTON, DC, 20006, US

(21) Appl. No.: 11/384,479

(22) Filed: Mar. 21, 2006

(30) Foreign Application Priority Data
Apr. 20, 2005 (KR) 2005-32896

(51) Int. Cl. B41J 29/38; B41J 2/01

(52) U.S. Cl. 400/76; 347/5; 347/16

(57) ABSTRACT

An image forming apparatus and a method of controlling the same. The method includes counting a total number of dots of an image formed on a sheet of recording medium during an image forming operation in an image forming unit employing a page width print head, calculating an optimal drying time that corresponds to the counted total number of dots from a lookup table, and controlling a drying time of the corresponding sheet of recording medium or a print time of a next sheet of recording medium. Accordingly, it is possible to maintain excellent print quality and effectively perform a high speed printing operation.

### CROSS-REFERENCE TO RELATED APPLICATIONS

This application claims the benefit of Korean Patent Application No. 2005-32896, filed Apr. 20, 2005, the disclosure of which is hereby incorporated herein by reference in its entirety.

### BACKGROUND OF THE INVENTION

1. Field of the Invention

The present general inventive concept generally relates to an inkjet image forming apparatus and a method of controlling the same and, more particularly, to an inkjet image forming apparatus and a method of controlling the same that is capable of controlling a drying time of an image formed on a recording medium.

2. Description of the Related Art

An inkjet image forming apparatus ejects fine droplets of liquid ink onto a recording medium to form a desired image. Therefore, when a next sheet of recording medium is discharged onto a previous sheet of recording medium having wet ink thereon, the ink on the previous sheet of recording medium may be smeared or deformed.

Therefore, a technology for drying the ink ejected on discharged sheet(s) of recording medium becomes necessary. The technology for drying the ink may include, for example, a method of drying the ink using a fan or heat energy, or a method of obtaining an ink drying time using a structural improvement of the inkjet image forming apparatus. However, these methods typically require a separate drying device.

U.S. Pat. No. 6,406,119 discloses a conventional technology capable of obtaining the drying time in a band unit of an inkjet head after forming an image that corresponds to the band unit of the inkjet head, without using a separate drying device. The drying time is obtained by calculating a number of dots that correspond to the band unit.

However, the conventional technology of U.S. Pat. No. 6,406,119 performs an image forming operation which consumes the drying time in every band unit whenever each sheet of recording medium is printed. That is, this conventional technology pauses the image forming operation in between the ejection of ink to each band unit to allow the ink ejected to each band unit to dry. Therefore, since a printing time of one sheet of the recording medium is lengthened, the conventional technology is not usable with an image forming apparatus that forms an image at a high speed using, for example, a page width print head (i.e., wide array type print head). In other words, the conventional technology simply slows down the image forming operation by pausing in between each band unit.

U.S. Pat. No. 6,808,253 discloses a conventional page width print head (i.e., wide array type print head). An inkjet image forming apparatus having the conventional page width print head ejects ink when the page width print head is stationary. This is different from the inkjet image forming apparatus including a print head that is moved by a carriage. The recording medium is moved from a paper feeding position to a paper discharging position at a predetermined uniform speed in order to form a uniform image, and the ink is ejected from the page width print head at a speed that is synchronized with a movement speed of the recording medium.

Therefore, since the inkjet image forming apparatus including the page width print head pauses the recording medium during the image forming operation to dry each individual band unit, it is difficult to utilize the high speed of the page width print head while allowing the drying time of each band unit to elapse when the image forming operation is paused.

### SUMMARY OF THE INVENTION

The present general inventive concept provides an inkjet image forming apparatus and a method of controlling the same that is capable of drying an image within a drying time that corresponds to a number of dots by determining a total number of dots on a sheet of recording medium.

Additional aspects of the present general inventive concept will be set forth in part in the description which follows and, in part, will be obvious from the description, or may be learned by practice of the general inventive concept.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an inkjet image forming apparatus including an image forming unit to form one or more images, and a controller to set a drying time based on a total number of dots on a sheet of recording medium in the image forming unit. The controller may compare the drying time of the sheet of recording medium with a print time of a next sheet of recording medium to be printed after the sheet of recording medium and control a print start time of the next sheet of recording medium.

The print time may be a total time used to pick-up the next sheet of recording medium, feed the next sheet of recording medium to the image forming unit, form an image on the next sheet of recording medium, and discharge the next sheet of recording medium having the image formed thereon. The image forming unit may include a page width print head, and the total number of dots may include a sum of a number of cyan, magenta, yellow, and black dots. In addition, the controller may count the total number of dots after the image forming unit begins an image forming operation on the sheet of recording medium.

The image forming apparatus may further include a memory unit having a lookup table in which the drying time may be pre-stored as a drying time that corresponds to the total number of dots.

In addition, the controller may compare a set print time and the drying time to delay an image forming operation of a next sheet of recording medium by a difference between the set print time and the drying time, when the drying time is longer than the set print time. The controller may perform the image forming operation of the next sheet of recording medium without an additional time delay when the drying time is shorter than the set print time.

The image forming apparatus may further include a memory unit having a lookup table in which the drying time may be pre-stored as a drying time that corresponds to the total number of dots. The controller may set a print time of the next sheet of recording medium as the corresponding drying time determined from the lookup table, when the image forming operation of the sheet of recording medium is completed.

The image forming apparatus may further include a memory unit having a lookup table in which the drying time is pre-stored and corresponds to the total number of dots. The total number of dots may be counted from print data when the print data is received by the controller such that the controller references the lookup table and sets a print time as the corresponding drying time.

The foregoing and/or other aspects of the present general inventive concept are also achieved by providing an image forming apparatus to form an image on one or more sheets of a recording medium, comprising an image forming unit to perform an image forming operation on a current sheet of the recording medium and to determine a drying time according to an amount of ink used on the current sheet, and a controller to determine a print time used in performing the image forming operation on the current sheet and to control the image forming unit to perform the image forming operation on a next sheet of the recording medium according to a comparison of the determined print time with the determined drying time.

The foregoing and/or other aspects of the present general inventive concept are also achieved by providing an image forming apparatus to form an image on one or more sheets of a recording medium, comprising an image forming unit to perform an image forming operation on a current sheet of the recording medium and to determine a drying time according to an amount of ink used on the current sheet, and a controller to set a print time based on the determined drying time and to control the image forming unit to perform the image forming operation on a next sheet of the recording medium according to the set print time.

The foregoing and/or other aspects of the present general inventive concept are also achieved by providing an image forming apparatus to form an image on one or more sheets of a recording medium, comprising an image forming unit to perform an image forming operation on a current sheet of the recording medium, and a controller to determine an amount of ink to be used on the current sheet of the recording medium in an image forming operation according to print data associated with the current sheet, to determine a drying time of the amount ink to be used on the current sheet, to set a print time to the determined drying time, and to control the image forming unit to perform the image forming operation on the current sheet of the recording medium according to the set print time.

The foregoing and/or other aspects of the present general inventive concept are also achieved by providing an image forming apparatus to form an image on one or more sheets of a recording medium, comprising a controller to control a print speed of the image forming apparatus according to an amount of ink used on each of the one or more sheets.

The foregoing and/or other aspects of the present general inventive concept are also achieved by providing an image forming apparatus to form an image on one or more sheets of a recording medium, comprising a memory unit to store a plurality of predetermined drying times of a sheet of the recording medium associated with a plurality of varying amounts of ink usable on the sheet of the recording medium, and a controller to monitor and set a print time of an image forming operation to one of the predetermined drying times stored in the memory unit.

The foregoing and/or other aspects of the present general inventive concept are also achieved by providing a method of controlling an inkjet image forming apparatus including counting a total number of dots ejected onto a sheet of recording medium on which an image is formed, and setting a drying time that corresponds to the counted total number of dots. The image may be formed using a page width print head, and the total number of dots may include a sum of a number of cyan, magenta, yellow, and black dots. Further, the total number of dots may be counted after or before an image forming operation begins.

Furthermore, the drying time may be determined from a lookup table stored in a memory unit to set a print time to the determined drying time. The setting of the drying time of the recording medium may include comparing a print time of a next sheet of recording medium to be printed after the sheet of recording medium with the determined drying time to determine a print start of the next sheet of recording medium.

The print time may be a total time used to pick up the next sheet of recording medium, feed the next sheet of recording medium to the inkjet image forming apparatus, form an image on the next sheet of recording medium, and discharge the next sheet of recording medium having the image formed thereon. In addition, the print time of the next sheet of recording medium may be set before a corresponding image forming operation is advanced, and when the drying time is longer than the print time, a print start of the next sheet of recording medium may be delayed by a difference between the print time and the drying time.

Further, when the drying time is shorter than the print time, an image forming operation of the next sheet of recording medium may be performed without an additional time delay. The method may further include pre-storing the drying time in a lookup table, and when an image forming operation is completed, a print time of a next sheet of recording medium may be set as the drying time. The total number of dots may be a sum of a number of dots ejected onto each line of the sheet of the recording medium.

The foregoing and/or other aspects of the present general inventive concept are also achieved by providing a method of controlling an inkjet image forming apparatus including receiving print data, setting a print time based on the received print data, forming an image on a sheet of recording medium using a page width print head when the print time is set, counting a total number of dots ejected onto the sheet of recording medium during the formation of the image, determining a drying time from a lookup table based on the counted total number of dots, and controlling a print start of a next sheet of recording medium according to the comparison of the determined drying time with the set print time.

When the determined drying time is longer than the set print time, the print start of the next sheet of recording medium may be delayed by a difference between the determined drying time and the set print time after the print time is completed, and when the determined drying time is equal to or shorter than the set print time, the printing operation of the next sheet of recording medium may begin without any time delay after the set print time is completed.

The foregoing and/or other aspects of the present general inventive concept are also achieved by providing a method of controlling an inkjet image forming apparatus including receiving print data, setting a print time based on the received print data, forming an image on a sheet of recording medium using a page width print head when the print time is set, counting a total number of dots ejected to the sheet of recording medium during the formation of the image, determining a drying time from a lookup table based on the counted total number of dots, and setting a print time of a next sheet of recording medium based on the drying time determined from the lookup table.

The foregoing and/or other aspects of the present general inventive concept are also achieved by providing a method of controlling an inkjet image forming apparatus including receiving print data, counting a total number of dots of a sheet of recording medium from the received print data, determining a drying time that corresponds to the total number of dots from a lookup table, and forming an image on the sheet of recording medium using a page width print head for the drying time. In addition, when the print data is received and the drying time is determined after setting the print time based on the print data, the print time may be set as the drying time.

The foregoing and/or other aspects of the present general inventive concept are also achieved by providing a method of forming an image on one or more sheets of a recording medium with an image forming apparatus, the method comprising performing an image forming operation on a current sheet of the recording medium and determining a drying time according to an amount of ink used on the current sheet, determining a print time spent in performing the image forming operation on the current sheet, and performing the image forming operation on a next sheet of the recording medium according to a comparison of the determined print time with the determined drying time.

The foregoing and/or other aspects of the present general inventive concept are also achieved by providing a method of forming an image on one or more sheets of a recording medium with an image forming apparatus, the method comprising performing an image forming operation on a current sheet of the recording medium and determining a drying time according to an amount of ink used on the current sheet, setting a print time to the determined drying time, and performing the image forming operation on a next sheet of the recording medium according to the set print time.

The foregoing and/or other aspects of the present general inventive concept are also achieved by providing a method of forming an image on one or more sheets of a recording medium with an image forming apparatus, the method comprising determining an amount of ink to be used on a current sheet of the recording medium in an image forming operation according to print data associated with the current sheet and determining a drying time of the amount ink to be used on the current sheet and setting a print time to the determined drying time, and performing the image forming operation on the current sheet of the recording medium according to the set print time.

The foregoing and/or other aspects of the present general inventive concept are also achieved by providing a method of forming an image on one or more sheets of a recording medium with an image forming apparatus, the method comprising controlling a print speed of the image forming apparatus according to an amount of ink used on each of the one or more sheets.

The foregoing and/or other aspects of the present general inventive concept are also achieved by providing a method of forming an image on one or more sheets of a recording medium with an image forming apparatus, the method comprising monitoring and setting a print time of an image forming operation according to a plurality of predetermined drying times of a sheet of the recording medium associated with a plurality of varying amounts of ink usable on the sheet of the recording medium.

The foregoing and/or other aspects of the present general inventive concept are also achieved by providing a computer readable medium containing executable code to form an image on one or more sheets of a recording medium with an image forming apparatus, the medium comprising an executable code to control a print speed of the image forming apparatus according to an amount of ink used on each of the one or more sheets.

### BRIEF DESCRIPTION OF THE DRAWINGS

These and/or other aspects of the present invention will become apparent and more readily appreciated from the following description of the embodiments, taken in conjunction with the accompanying drawings of which:

FIG. 1 is a block diagram illustrating a multifunction printer including an image forming apparatus in accordance with an embodiment of the present general inventive concept;

FIG. 2 is a flowchart illustrating a method of controlling an image forming apparatus in accordance with an embodiment of the present general inventive concept;

FIG. 3 is a flowchart illustrating a method of controlling an image forming apparatus in accordance with another embodiment of the present general inventive concept; and

FIG. 4 is a flowchart illustrating a method of controlling an image forming apparatus in accordance with yet another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

An image forming apparatus in accordance with an embodiment of the present general inventive concept may be a multifunction printer (MFP) having an inkjet printer or an inkjet image forming unit.

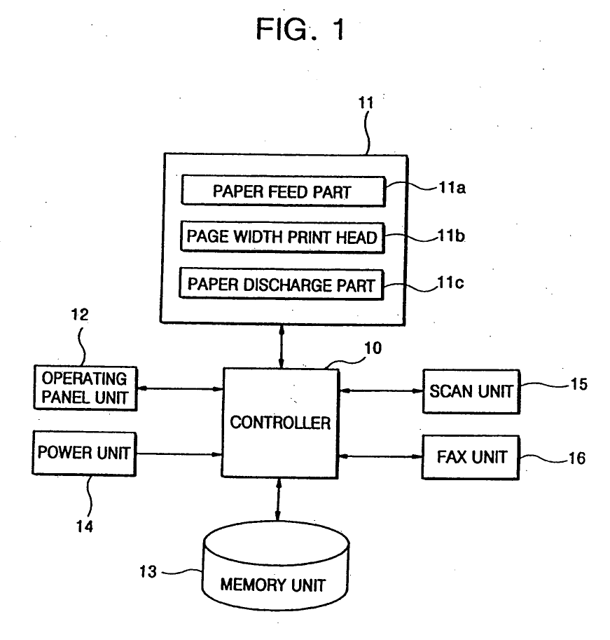

FIG. 1 illustrates an example of the MFP employing the image forming apparatus in accordance with the present embodiment. The MFP includes a controller 10, a memory unit 13, an image forming unit 11, an operating panel unit 12, and a power unit 14. The MFP may further include a scan unit 15 and a fax unit 16.

The controller 10 controls an overall operation of the MFP. The memory unit 13 stores various data to control operations of the MFP, including a lookup table having information about a print time and a drying time of an image.

The print time refers to an amount of time spent to pick-up a sheet of recording medium, feed the sheet of recording medium into the image forming apparatus, form the image on the sheet of recording medium, and discharge the sheet of recording medium having the image formed thereon. In other words, the print time refers to the amount of time an image forming operation performed on a sheet of recording medium requires. The print time may vary according to various print modes, or may be uniformly set in the same print mode, regardless of an amount of data to be printed per sheet of the recording medium. In other words, the various print modes may correspond to various print times. Additionally, the image forming apparatus can reduce or increase the print time by reducing or increasing the time required to perform the image forming operation.

The lookup table stores the drying time set based on a total number of dots ejected onto a sheet of recording medium. The lookup table may store a plurality of drying times that correspond to a plurality of different numbers of dots. Data used to calculate the drying time may include a printing resolution, a number of nozzles, a number of ejected droplets, a type of recording medium being used (e.g., an overhead projector (OHP) film), a type of image (e.g., black/white or color), and a type of print data (e.g., characters or drawings). The drying time may be obtained from data measured through a test that may be repeated, and may be previously set as the result of the tests. The drying time may be shorter or longer than the print time according to a number of dots (of ink) printed onto the sheet of the recording medium. The drying time may be determined according to the number of dots (printed or to be printed) on the sheet of the recording medium, and may be compared to the amount of time required to perform the image forming operation from the picking up of the sheet of the recording medium through the discharging of the sheet of recording medium having the image formed thereon (i.e., the print time).

In addition, the controller 10 may adjust the print time for different sheets of recording medium of a single print job. In other words, the controller 10 may control the image forming unit 11 to perform a print job including a plurality of image forming operations of a plurality of sheets of recording medium according to corresponding print times. Alternatively, the controller 10 may adjust the print time for different sheets of recording medium of more than one print job.

The image forming unit 11 forms an image on the recording medium when the print data is transmitted from the controller 10. The image forming unit 11 may include a paper feed part 11a, a page width print head 11b (i.e., a wide array type print head), and a paper discharge part 11c.

The operating panel unit 12 enables a user to input conditions or functions to form the image. For this purpose, the operating panel unit 12 may include a number of operating keys and/or a display unit to display various information. The power unit 14 provides power to the image forming apparatus.

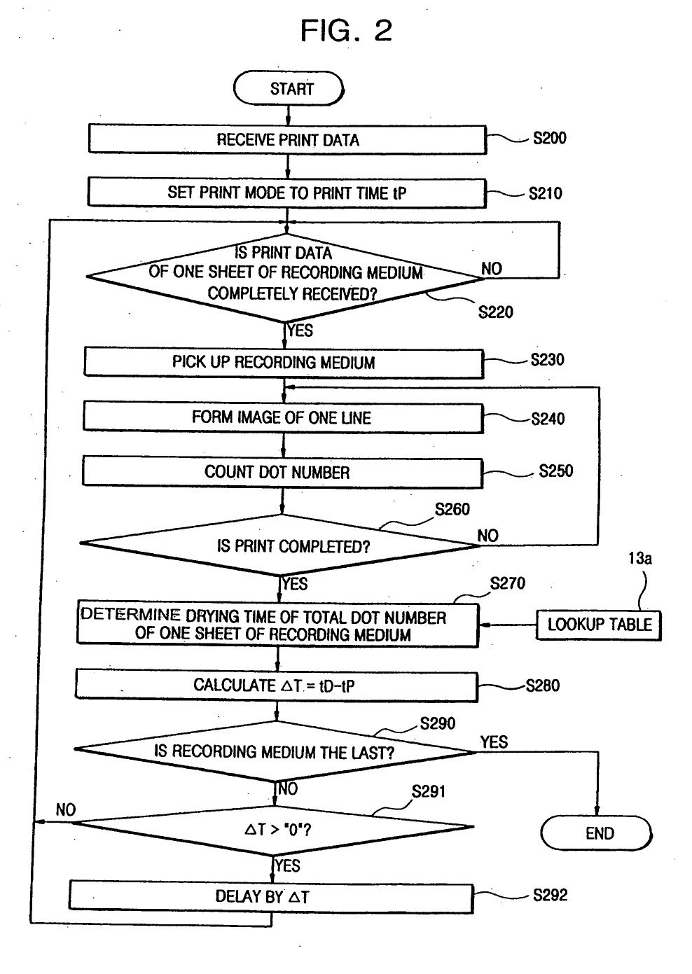

Hereinafter, various embodiments of a method of controlling an image forming apparatus in accordance with the present general inventive concept will be described. The various embodiments of the method of controlling the image forming apparatus may be performed by the controller 10 of the image forming apparatus of FIG. 1. Accordingly, the various embodiments of FIGS. 2 to 4 are described below with reference to FIG. 1. However, it should be understood that the methods of FIGS. 2 to 4 may be applied to other image forming apparatuses.

FIG. 2 is a flowchart illustrating a method of controlling the image forming apparatus in accordance with an embodiment of the present general inventive concept. As illustrated in FIG. 2, when a user inputs a print request to print certain data through a host device, the host device converts the certain data (e.g., image data) into print data using an output driver. The converted print data is transmitted to the image forming apparatus, and the controller 10 of the image forming apparatus receives the print data per sheet of recording medium (to be printed) and stores the print data that corresponds to each sheet of recording medium in the memory unit 13 (operation S200).

When the print data is received by the controller 10, a print mode is set to a set print time tP (operation S210). In other words, the set print time tP may correspond to a print mode that is selected and set. When the print mode is set, the controller 10 determines whether the print data of one sheet of recording medium is completely received (operation S220). When the controller 10 determines that the print data of one sheet of the recording medium has been completely received, the one sheet of recording medium is picked up (operation S230), and the image forming unit 11 then begins to form an image of one line of the print data of the one sheet of the recording medium using the page width print head 11b (operation S240).

When the image formation of one line of the one sheet of the recording medium is performed, the controller 10 counts a total number of dots of the one line ejected from the page width print head 11b (operation S250). The total number of dots may include numbers of dots of cyan, magenta, yellow, and black ink added together.

A method of counting the number of dots includes converting the print data to a “0” or a “1” depending on whether cyan, magenta, yellow, or black colors are ejected. Alternatively, the total number of dots can be counted depending on whether a nozzle ejects the colors. That is, the print data is converted to a “1” when the ejection is performed, and a “0” when the ejection is not performed. The data converted to “1” is then accumulated. The counted number of dots of the one line is then stored in the memory unit 13.

When the number of dots of the one line is completely counted, the controller 10 determines whether the image forming operation (i.e., the print) is complete (operation S260). That is, when no more print data of the one line remains to be printed, the controller 10 determines that the image forming operation of the one line is completed. When print data of the one line remains to be printed, the controller 10 continues to perform the image forming operation and count of the number of dots in each line (i.e., remaining lines) of print data printed to the one sheet of recording medium. These operations are continuously and repeatedly performed until the image forming operation of the one sheet of recording medium (i.e., a printed sheet of recording medium) is completed. Therefore, the total number of dots of the one sheet of the recording medium is accumulated line by line and stored in the memory unit 13.

A lookup table 13a may be pre-stored in the memory unit 13. Therefore, when the image forming operation of the one sheet of recording medium (i.e., the printed sheet) is completed, the controller 10 references the lookup table 13a and determines a drying time tD that corresponds to the total number of dots on the one sheet of recording medium (operation S270). The controller 10 then compares the determined drying time tD with the set print time tP. That is, the calculation of the following formula 1 is performed (operation S280).
ΔT=tD−tP [Formula 1]
where tD represents the drying time stored in the lookup table 13a of the memory unit 13, tP represents the set print time, and ΔT represents a calculated delay value.

After performing the calculation, the controller 10 determines whether the one sheet of recording medium (i.e., the printed sheet) is a last sheet of recording medium to be printed (operation S290). The controller 10 terminates the image forming operation when the one sheet of recording medium is determined to be the last sheet of recording medium to be printed. The controller 10 determines whether the calculated delay value ΔT is greater than “0” when the one sheet of the recording medium is determined not to be the last sheet of recording medium to be printed (operation S291). When the calculated delay value ΔT is equal to or less than “0”, the controller 10 moves to the operation S220 without allowing any time elapse and performs the image forming operation of a next sheet of recording medium. In this case the print time tP is determined to be longer than the drying time tD of the corresponding total number of dots on the one sheet of the recording medium (i.e., the printed sheet). Therefore, the controller 10 determines that the image formed on the printed sheet of recording medium has had a sufficient amount of time to dry, even though no additional amount of time is necessary other than the print time tP to dry the image formed on the one sheet of recording medium.

On the other hand, when the calculated delay value ΔT is greater than “0”, after a time that corresponds to the calculated delay value ΔT elapses, the controller 10 moves to the operation S220 to perform the image forming operation on the next sheet of recording medium (operation S292). In this case, the print time tP is determined to be shorter than the drying time tD of the corresponding total number of dots on the one sheet of the recording medium (i.e., the printed sheet). Therefore, the controller 10 determines that the image can be completely dried when an additional time delay (i.e., the calculated time delay ΔT) elapses. The controller 10 adds the calculated time delay ΔT to the print time tP to obtain the drying time tD. Thus, once the image forming operation for the one sheet of recording medium (i.e., the printed sheet) is complete, the controller 10 allows the calculated time delay ΔT to elapse in order to properly dry the image formed on the printed sheet, before beginning the image forming operation on the next sheet of recording medium.

As described above, the print time tP and the drying time tD can be compared with each other to control a print start time of sheets of the recording medium. Since the image forming operation of the next sheet of recording medium can be performed, after the image formed on the one sheet of recording medium (i.e., the printed sheet) is sufficiently dried, it is possible to prevent the image on the printed sheet of recording medium, which has been discharged from the image forming apparatus, from being smeared or deformed by the next sheet of recording medium.

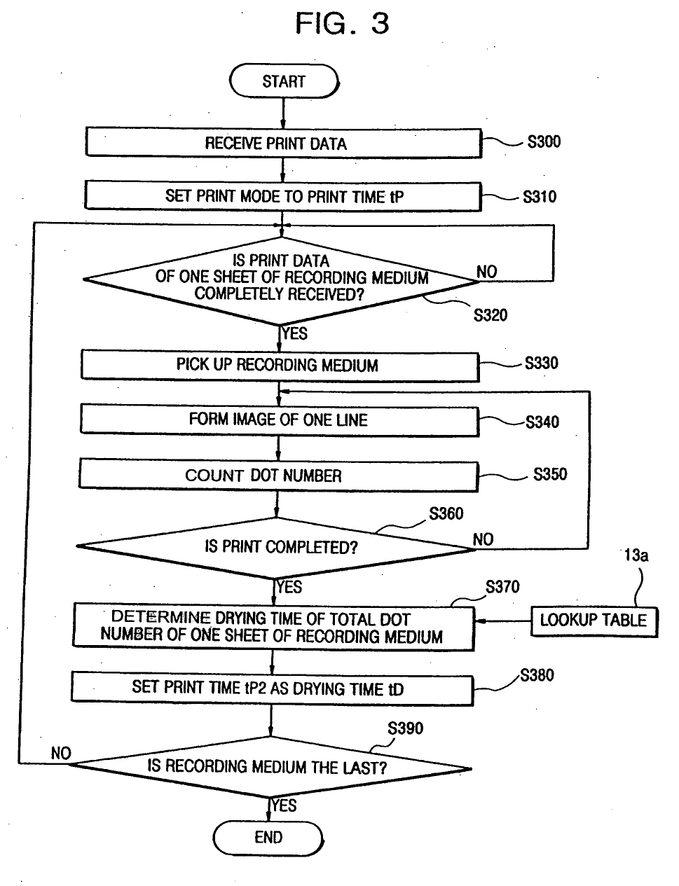

FIG. 3 is a flowchart illustrating a method of controlling the image forming apparatus in accordance with another embodiment of the present general inventive concept.

When a user inputs a print request to print certain data through a host device, the computer converts the certain data (e.g., image data) into print data using an output driver to transmit the converted print data to the controller 10. The controller 10 receives the print data per sheet of recording medium to be printed (operation S300).

When the print data is received by the controller 10, a print mode is set to a set print time tP (operation S310). In other words, the set print time tP may correspond to a print mode that is selected and set. When the print mode is set, the controller 10 determines whether the print data of one sheet of recording medium is completely received (operation S320). When the controller 10 determines that the print data of the one sheet of recording medium has been completely received, the image forming unit 11 performs a picking up operation (operation S330) on the one sheet of the recording medium and performs an image forming operation (operation S340) on the picked up sheet of recording medium. The image is formed on the one sheet of recording medium using the page width print head 11b.

When the image is formed, the controller 10 counts a total number of dots of ink ejected from the page width print head 11b (operation S350). The counted total number of dots of the image formed on the one sheet of the recording medium is then stored in the memory unit 13. The controller 10 then determines whether the image forming operation (i.e., the print) is completed (operation S360). When the controller 10 determines that the image forming operation is completed, the controller 10 terminates the counting of the number of dots. A lookup table 13a may be pre-stored in the memory unit 13.

Therefore, the controller 10 determines a drying time tD that corresponds to the counted total number of dots from the lookup table 13a (operation S370). The controller 10 automatically sets a next print time tP2 of a next sheet of recording medium to the determined drying time tD. That is, the next print time tP2 is substituted with the drying time tD.

The controller 10 then determines whether the one sheet of the recording medium (i.e., the printed sheet) is a last sheet of recording medium by determining whether print data of another sheet of recording medium has been received (i.e., exists) (operation S390). When the print data for another sheet of recording medium exists (i.e., has been received), the controller 10 moves to the operation S320 to perform the image forming operation of the next sheet of recording medium. The next print time tP2 of the next sheet of recording medium has already been set to the drying time tD. Therefore, the next print time tP2 of the next sheet of recording medium is selected such that the image forming operation takes an amount of time that is equal to the drying time of a previous sheet (i.e., the one sheet) of recording medium. The controller 10 then terminates the image forming operation when no more print data is received and the next sheet of recording medium is the last sheet.

In order to print the next sheet of recording medium, when the next print time tP2, which is substituted with the drying time tD, is slower than the print time tP that is initially set, the image forming apparatus delays a print speed. The print speed can be decreased by reducing at least one of a pick up time of the recording medium, an image forming speed, and a feeding time of the recording medium. On the other hand, when the next print time tP2, which is substituted with the drying time tD, is faster than the print time tP that is initially set, the print speed can be increased by increasing at least one of the pick up time of the recording medium, the image forming speed, and the feeding time of the recording medium. Therefore, it is possible to vary and/or control the print speed according to an amount of time required for the image to dry on the recording medium.

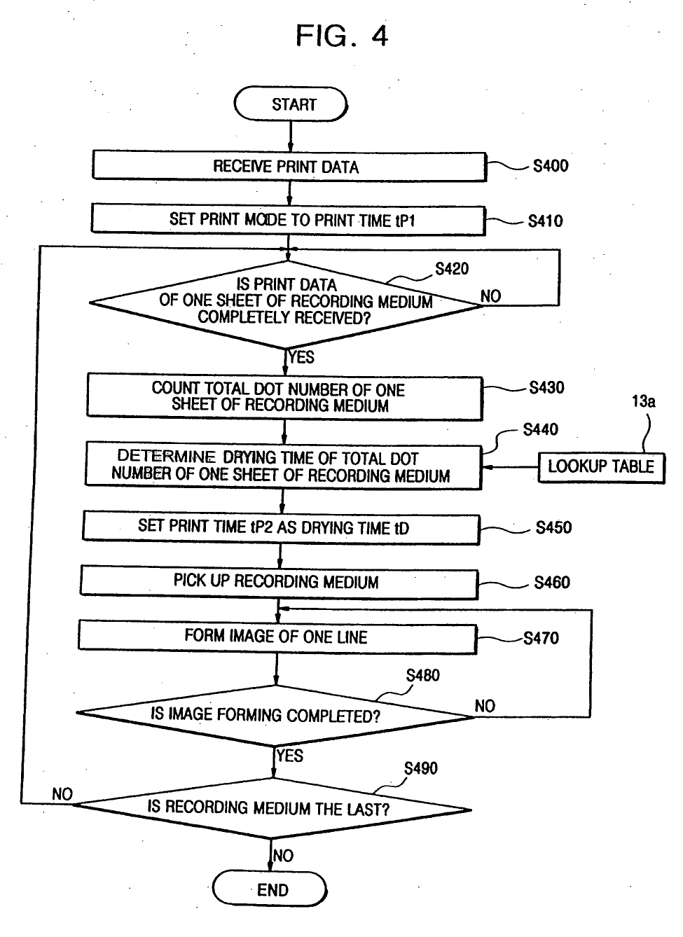

FIG. 4 is a flowchart illustrating a method of controlling an image forming apparatus in accordance with another embodiment of the present general inventive concept.

When a user inputs a print request to print certain data through a host device, the host device converts the certain data (e.g., image data) into print data using an output driver to transmit the converted print data to the controller 10. The controller 10 receives the print data per sheet of recording medium to be printed (operation S400).

When the print data is received by the controller 10, a print mode is set to a set print time tP1 (S410). In other words, the set print time tP1 may correspond to a print mode that is selected and set. The present embodiment enables the print mode to be set together with the print time tP1. When the print mode is set, the controller 10 determines whether the print data of one sheet of recording medium is completely received (operation S420).

When the controller 10 determines that the print data of the one sheet of recording medium has been completely received, a total number of dots is counted from the received print data of the one sheet of recording medium (operation S430). That is, the total number of dots is counted from the received print data before the image forming apparatus performs the image forming operation. The counted total number of dots is then stored in the memory unit 13. A lookup table 13a may be pre-stored in the memory unit 13.

The controller 10 determines a drying time tD that corresponds to the total number of dots of the one sheet of recording medium from the lookup table 13a (operation S440). The controller 10 then sets a new print time tP2 as the determined drying time tD. Thereafter, the image forming operation is performed for a time that corresponds to the new print time tP2. The image forming unit 11 performs a picking up operation (operation S460) of the recording medium and a line image forming operation to form an image of one line (operation S470) of the picked up recording medium, and when the line image forming operation is performed, the controller 10 determines whether the image forming operation of the one sheet of recording medium is completed (operation S480). The determination of whether the image forming operation is complete can be performed in between each line image forming operation for the print data of each line of the one sheet of recording medium. The image may be formed using the page width print head 11b.

Therefore, when the new print time tP2 is set to the drying time tD, the controller 10 performs the image forming operation at a speed that corresponds to the drying time tD by varying the print speed. Accordingly, the print speed can be adjusted by increasing or reducing at least one of the pick up time of the recording medium, the image forming speed, and the feeding time of the recording medium.

The controller 10 then determines whether the one sheet of the recording medium is a last sheet of the recording medium by determining whether the print data of another sheet of recording medium has been received by the controller 10 (i.e., whether more print data exists) (operation S490). When the print data of another sheet of recording medium is received, the controller 10 proceeds to the operation S420 to perform the image forming operation of a next sheet of recording medium. The controller 10 terminates the image forming operation when the print data of another sheet does not exist. The method of the present embodiment may be performed during an image forming operation of a first (or current) sheet of recording medium. In addition, the present embodiment allows images formed on sheets of recording medium to dry by adjusting the corresponding print time thereof during or before the corresponding image forming operation, rather than by adjusting the print time of the next sheet of recording medium. In other words, the present embodiment does not determine a print time of a current sheet according to a drying time of a previous sheet. Instead, the present embodiment determines the print time of the current sheet according to print data to be printed to (or being printed on) the current sheet.

The present general inventive concept may be embodied in hardware, software, or a combination thereof. For example, the present general inventive concept may be embodied by a computer running a program from a computer-readable medium, including but not limited to storage media such as magnetic storage media (ROMs, RAMs, floppy disks, magnetic tapes, etc.), optically readable media (CD-ROMs, DVDs, etc.), and carrier waves (transmission over the internet). The present general inventive concept may be embodied as a computer-readable medium having a computer-readable program code to cause a number of computer systems connected via a network to effect distributed processing.

As described above, the various embodiments of the present general inventive concept are capable of obtaining an optimal drying time according to a total number of dots ejected onto a recording medium, improving an image forming speed by varying a print speed according to the optimal drying time, and effectively drying the image.

As can be seen from the foregoing, an inkjet image forming apparatus and a method of controlling the same in accordance with the various embodiments of the present general inventive concept are capable of preventing an ink image from smearing or deforming, thereby maintaining an excellent print quality by obtaining an optimal drying time of each recording medium through a counting operation of a total number of dots ejected onto the sheets of recording medium. The various embodiments of the present general inventive concept do not require an additional drying device, and effectively form the image in the image forming apparatus to perform a high speed image forming operation using a page width print head (i.e., wide array type head).

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet image forming apparatus, comprising:
an image forming unit to form one or more images; and
a controller to set a drying time based on a total number of dots on a sheet of recording medium in the image forming unit.

2. The inkjet image forming apparatus according to claim 1, wherein the controller compares the drying time of the sheet of recording medium with a print time of a next sheet of recording medium to be printed after the sheet of recording medium and controls a print start time of the next sheet of recording medium accordingly.

3. The inkjet image forming apparatus according to claim 2, wherein the print time is a total time used to pick-up the next sheet of recording medium, feed the next sheet of recording medium to the image forming unit, form an image on the next sheet of recording medium, and discharge the next sheet of recording medium having the image formed thereon.

4. The inkjet image forming apparatus according to claim 1, wherein the image forming unit comprises a page width print head.

5. The inkjet image forming apparatus according to claim 1, wherein the total number of dots includes a sum of a number of cyan, magenta, yellow, and black dots.

6. The inkjet image forming apparatus according to claim 1, wherein the controller counts the total number of dots after the image forming unit begins an image forming operation on the sheet of recording medium.

7. The inkjet image forming apparatus according to claim 1, further comprising:
a memory unit having a lookup table in which the drying time is pre-stored as a drying time that corresponds to the total number of dots.

8. The inkjet image forming apparatus according to claim 1, wherein the controller compares a set print time with the drying time to delay an image forming operation of a next sheet of recording medium by a difference between the set print time and the drying time, when the drying time is longer than the set print time.

9. The inkjet image forming apparatus according to claim 8, wherein the controller performs the image forming operation of the next sheet of recording medium without an additional time delay when the drying time is shorter than the set print time.

10. The inkjet image forming apparatus according to claim 1, further comprising:
a memory unit having a lookup table in which the drying time is pre-stored as a drying time that corresponds to the total number of dots, and the controller sets a print time of a next sheet of recording medium as the corresponding drying time determined from the lookup table, when the image forming operation of the sheet of recording medium is completed.

11. The inkjet image forming apparatus according to claim 1, further comprising:
a memory unit having a lookup table in which the drying time is pre-stored and corresponds to the total number of dots,
wherein the total number of dots is counted from print data when the print data is received by the controller such that the controller references the lookup table and sets a print time as the corresponding drying time.

12. An image forming apparatus to form an image on one or more sheets of a recording medium, comprising:
an image forming unit to perform an image forming operation on a current sheet of the recording medium and to determine a drying time according to an amount of ink used on the current sheet; and
a controller to determine a print time used in performing the image forming operation on the current sheet and to control the image forming unit to perform the image forming operation on a next sheet of the recording medium according to a comparison of the determined print time with the determined drying time.

13. The apparatus according to claim 12, wherein the controller compares the determined print time with the determined drying time such that when the determined drying time is longer than the determined print time the controller controls the image forming unit to delay performing the image forming operation on the next sheet, and when the determined drying time is shorter than the determined print time the controller controls the image forming unit to perform the image forming operation on the next sheet immediately upon completion of the image forming apparatus on the current sheet.

14. The apparatus according to claim 12, further comprising:
a memory unit to store a plurality of predetermined drying times associated with a plurality of predetermined numbers of ink ejections, wherein the controller determines the drying time by determining a number of ink ejections onto all lines of the current sheet and referencing the memory unit to determine the drying time according to the amount of ink used on the current sheet.

15. An image forming apparatus to form an image on one or more sheets of a recording medium, comprising:
an image forming unit to perform an image forming operation on a current sheet of the recording medium and to determine a drying time according to an amount of ink used on the current sheet; and
a controller to set a print time based on the determined drying time and to control the image forming unit to perform the image forming operation on a next sheet of the recording medium according to the set print time.

16. The apparatus according to claim 15, wherein the set print time is set to be equal to the determined drying time.

17. The apparatus according to claim 15, further comprising:
a memory unit to store a plurality of predetermined drying times associated with a plurality of predetermined numbers of ink ejections, wherein the controller determines the drying time by determining a number of ink ejections onto all lines of the current sheet by referencing the memory unit to determine the drying time according to the amount of ink used on the current sheet.

18. The apparatus according to claim 15, wherein the controller sets the print time as the determined drying time by adjusting a first print time during which the current sheet is printed to a second print time during which the next sheet is to be printed such that the image forming unit adjusts an amount of time used to perform the image forming operation.

19. An image forming apparatus to form an image on one or more sheets of a recording medium, comprising:
an image forming unit to perform an image forming operation on a current sheet of the recording medium; and
a controller to determine an amount of ink to be used on the current sheet of the recording medium in an image forming operation according to print data associated with the current sheet, to determine a drying time of the amount ink to be used on the current sheet, to set a print time to the determined drying time, and to control the image forming unit to perform the image forming operation on the current sheet of the recording medium according to the set print time.

20. The apparatus according to claim 19, further comprising:
a memory unit having a plurality of predetermined drying times stored therein to correspond to a plurality of different numbers of ink ejections, wherein the controller determines the amount of ink to be used on the current sheet by determining a number of ink ejections to be performed by the image forming unit on the current sheet, and the controller determines the drying time by accessing the memory unit and selecting the drying time that corresponds to the number of ink ejections to be performed on the current sheet.

21. The apparatus according to claim 19, wherein the controller increases or decreases a print speed of the image forming operation according to a difference between the set print time and a previously set print time.

22. An image forming apparatus to form an image on one or more sheets of a recording medium, comprising:
a controller to control a print speed of the image forming apparatus according to an amount of ink used on each of the one or more sheets.

23. A method of controlling an inkjet image forming apparatus, the method comprising:
counting a total number of dots ejected onto a sheet of recording medium on which an image is formed; and
setting a drying time that corresponds to the counted total number of dots.

24. The method according to claim 23, wherein the image is formed using a page width print head.

25. The method according to claim 23, wherein the total number of dots includes a sum of a number of cyan, magenta, yellow, and black dots.

26. The method according to claim 23, wherein the total number of dots is counted after an image forming operation begins.

27. The method according to claim 23, wherein the total number of dots is counted from print data before an image forming operation begins.

28. The method according to claim 27, wherein the drying time is determined from a lookup table stored in a memory unit to set a print time as the drying time.

29. The method according to claim 23, wherein the setting the of the drying time of the recording medium comprises comparing a print time of a next sheet of recording medium to be printed after the sheet of recording medium with the determined drying time to determine a print starting time of the next sheet of recording medium.

30. The method according to claim 29, wherein the print time is a total time used to pick up the next sheet of recording medium, feed the next sheet of recording medium to the inkjet image forming apparatus, form an image on the next sheet of recording medium, and discharge the next sheet of recording medium having the image formed thereon.

31. The method according to claim 29, wherein the print time of the next sheet of recording medium is set before a corresponding image forming operation is advanced, and when the drying time is longer than the print time, a print start of the next sheet of recording medium is delayed by a difference between the set print time and the drying time.

32. The method according to claim 29, wherein, when the drying time is shorter than the set print time, an image forming operation of the next sheet of recording medium is performed without an additional time delay.

33. The method according to claim 23, further comprising:
pre-storing the drying time in a lookup table, and when an image forming operation is completed, a print time of a next sheet of recording medium is set as the drying time.

34. The method according to claim 23, wherein the total number of dots is a sum of a number of dots ejected onto each line of the sheet of the recording medium.

35. A method of controlling an inkjet image forming apparatus, the method comprising:
receiving print data;
setting a print time based on the received print data;
forming an image on a sheet of recording medium using a page width print head when the print time is set;
counting a total number of dots ejected to the sheet of recording medium during the formation of the image;
determining a drying time from a lookup table stored in a memory unit based on the counted total number of dots; and
controlling a print start of a next sheet of recording medium depending on a comparison of the determined drying time with the set print time.

36. The method according to claim 35, wherein, when the determined drying time is longer than the print time, the set print start of the next sheet of recording medium is delayed by a difference between the determined drying time and set the print time after the print time is completed.

37. The method according to claim 35, wherein, when the determined drying time is not more than the set print time, the printing operation of the next sheet of recording medium starts without any time delay after the set print time is completed.

38. A method of controlling an inkjet image forming apparatus, the method comprising:
receiving print data;
setting a print time based on the received print data;
forming an image on a sheet of recording medium using a page width print head when the print time is set;
counting a total number of dots ejected to the sheet of recording medium during the formation of the image;
determining a drying time from a lookup table stored in a memory unit based on the counted total number of dots; and
setting a print time of a next sheet of recording medium based on the drying time determined from the lookup table.

39. A method of controlling an inkjet image forming apparatus, the method comprising:
receiving print data;
counting a total number of dots of a sheet of recording medium from the received print data;
determining a drying time that corresponds to the total number of dots from a lookup table; and
forming an image on the sheet of recording medium using a page width print head for the drying time.

40. The method according to claim 39, wherein, when the print data is received and the drying time is determined after setting the print time based on the print data, the print time is set as the drying time.

41. A method of forming an image on one or more sheets of a recording medium with an image forming apparatus, the method comprising:
performing an image forming operation on a current sheet of the recording medium and determining a drying time according to an amount of ink used on the current sheet;
determining a print time spent in performing the image forming operation on the current sheet; and
performing the image forming operation on a next sheet of the recording medium according to a comparison of the determined print time with the determined drying time.

42. The method according to claim 41, wherein the performing of the image forming operation on the next sheet comprises comparing the determined print time with the determined drying time such that when the determined drying time is longer than the determined print time the performing of the image forming operation on the next sheet is delayed, and when the determined drying time is shorter than the determined print time the performing of the image forming operation on the next sheet is commenced immediately upon completion of the performing of the image forming apparatus on the current sheet.

43. The method according to claim 41, wherein the determining of the drying time comprises determining a number of ink ejections onto all lines of the current sheet and referencing a memory unit that stores a plurality of predetermined drying times associated with a plurality of predetermined numbers of ink ejections to determine the drying time according to the amount of ink used on the current sheet.

44. A method of forming an image on one or more sheets of a recording medium with an image forming apparatus, the method comprising:
performing an image forming operation on a current sheet of the recording medium and determining a drying time according to an amount of ink used on the current sheet;
setting a print time to the determined drying time; and
performing the image forming operation on a next sheet of the recording medium according to the set print time.

45. The method according to claim 44, wherein the determining of the drying time comprises determining a number of ink ejections onto all lines of the current sheet and referencing a memory unit that stores a plurality of predetermined drying times associated with a plurality of predetermined numbers of ink ejections to determine the drying time according to the amount of ink used on the current sheet.

46. The method according to claim 44, wherein the setting of the print time to the determined drying time comprises adjusting a first print time during which the current sheet is printed to a second print time during which the next sheet is to be printed such that the image forming apparatus adjusts an amount of time used to perform the image forming operation.

47. A method of forming an image on one or more sheets of a recording medium with an image forming apparatus, the method comprising:
determining an amount of ink to be used on a current sheet of the recording medium in an image forming operation according to print data associated with the current sheet; and
determining a drying time of the amount ink to be used on the current sheet and setting a print time to the determined drying time; and
performing the image forming operation on the current sheet of the recording medium according to the set print time.

48. The method according to claim 47, wherein:
the determining of the amount of ink to be used on the current sheet comprises determining a number of ink ejections onto the current sheet to be performed by an image forming unit; and
the determining of the drying time comprises accessing a memory unit having a plurality of predetermined drying times stored therein to correspond to a plurality of different numbers of ink ejections and selecting the drying time that corresponds to the number of ink ejections to be performed on the current sheet.

49. The method according to claim 47, wherein the performing of the image forming operation on the current sheet of the recording medium comprises increasing or reducing a print speed according to a difference between the set print time and a previously set print time.

50. A method of forming an image on one or more sheets of a recording medium with an image forming apparatus, the method comprising:
controlling a print speed of the image forming apparatus according to an amount of ink used on each of the one or more sheets.

51. A computer readable medium containing executable code to form an image on one or more sheets of a recording medium with an image forming apparatus, the medium comprising:
an executable code to control a print speed of the image forming apparatus according to an amount of ink used on each of the one or more sheets.
